(19) United States
(12) Patent Application Publication
(10) Pub. No.: US 2016/0066159 A1
(43) Pub. Date: Mar. 3, 2016

(54) CURRENT EVENT AND OUTSIDE EVENT DATA TRANSMISSION TO EVENTGOER DEVICES

(71) Applicant: ProSports Technologies, LLC, Miami, FL (US)

(72) Inventors: John E. Cronin, Bonita Springs, FL (US); Jonathan T. Goguen, Brookline, NH (US)

(21) Appl. No.: 14/838,129

(22) Filed: Aug. 27, 2015

Related U.S. Application Data
(60) Provisional application No. 62/043,163, filed on Aug. 28, 2014.
(60) Provisional application No. 62/043,175, filed on Aug. 28, 2014.

(51) Int. Cl. H04W 4/04; H04W 4/02; G06Q 50/26

(52) U.S. Cl. CPC H04W 4/04; G06Q 50/265; H04W 4/021

(57) ABSTRACT

An event venue with a performance area (e.g., a stage, a sports field) and an eventgoer area (e.g., stadium seating, bleachers) may include beacons and cameras throughout the performance area and eventgoer area. The beacons and cameras may each record event occurrence data (e.g., images, audio, video) of particular occurrences (e.g., sport goals, songs played, eventgoer activities) during an event (e.g., sports game, concert) at the event venue. The beacons and cameras may send this event occurrence data to a transmission system, which may also receive similar event occurrence data from other event venues. The transmission system may convert selected event occurrence data from a first format to a second format, and then may output the event occurrence data in the second format through one or more local wireless transmitters. Eventgoers in the transmission zones of these transmitters may then receive the event occurrence data at their mobile devices.

### CROSS-REFERENCE TO RELATED APPLICATIONS

The present application claims the priority benefit of U.S. provisional application No. 62/043,163 filed Aug. 28, 2014 entitled “Offline In-Event Data To Fans Enhancing Experience to Coordinate Fan Activities,” and of U.S. provisional application No. 62/043,175 filed Aug. 28, 2014 entitled “Offline In-Event Data To Fans Enhancing Experience With Outside Event Data,” the disclosures of which are hereby incorporated by reference.

### BACKGROUND

1. Field of Invention

The present invention generally relates to event venue security systems. More specifically, the present invention relates to event venue security systems that wirelessly transmit security information to security personnel and to eventgoers.

2. Description of the Related Art

Event venues (e.g., sports stadiums/arenas, concert/theatre auditoriums), typically host exciting events that eventgoers enjoy attending. Typically, event venues include a performance area, such as a sport field, or a sport arena, or a sport court, or a concert stage, or a lecture stage. Typically, event venues include an eventgoer area, such as stadium seating, bleachers, theater seating, or a standing room eventgoer area. Some parts of the eventgoer area generally provide better views or better acoustics of particular event occurrences in the performance area than other parts of the eventgoer area. Some event occurrences in the performance area might not normally be visible or audible in the eventgoer area at all, such as sports team “huddle” meetings.

Event venues sometimes have cameras, though such cameras are typically trained on a performance area (e.g., a sports field/court, a concert/theatre stage) in order to record a performance or game for the purpose of broadcasting it on television or selling recorded copies of the performance.

Eventgoers often own user devices, such as smartphone devices or tablet devices, and often carry such devices on their person to event venues while attending events. Such user devices can often send and accept wired or wireless communications via a network, such as a local area network (LAN) or wireless local area network (WLAN), or via the Internet.

Traditionally, the field of digital communications includes wired and wireless transfer of information. Digital communications may include direct communications in which information is transmitted from a sender device to a recipient device, and may also include “indirect” communications in which information is transmitted from a sender device, through one or more “intermediary” or “middleman” devices, and eventually to a recipient device.

One example of wired transfer includes data transmitted from a sender device to a recipient device using a Universal Serial Bus (USB) cable. Another example of a wired transfer includes data transmitted within a private Local Area Network (LAN) from a sender device to a router through a sender Ethernet cable, and from the router to a recipient device through a recipient Ethernet cable.

One example of wireless transfer includes data transmitted from a sender device to a recipient device using a Bluetooth protocol connection. Another example of a wired transfer includes data transmitted within a private Wireless Local Area Network (WLAN) from a sender device to a router through a wireless Wi-Fi connection, and from the router to a recipient device through a wireless Wi-Fi connection. Other examples of wireless transfer include Bluetooth communications, Visible Light Communications (VLC), radio wave communications, microwave communications, or sonic communication.

Eventgoers sometimes may wish to obtain data about the event that they are attending, or about other events, or about sports teams or other performers, or about particular event rules or regulations, or about activities that eventgoers can participate in during the event.

Thus, an improved event venue communication system is needed.

### SUMMARY OF THE CLAIMED INVENTION

One exemplary method for event venue communication includes receiving a first plurality of recorded datasets from a plurality of recording devices located at a plurality of locations within a performance area of an event venue. The exemplary method also includes combining the first plurality of recorded datasets into a first venue dataset. The exemplary method also includes receiving one or more secondary venue datasets. The exemplary method also includes receiving a selection input identifying a venue associated with a selected venue dataset, wherein the selected venue dataset is one of the first venue dataset or one of the one or more secondary venue datasets. The exemplary method also includes transmitting at least a subset of the selected venue dataset wirelessly to one or more receiver devices using one or more local wireless transmitters, where each local wireless transmitter of the one or more local wireless transmitters transmits data within a wireless transmission zone near the local wireless transmitter, wherein each wireless transmission zone includes at least a portion of an eventgoer area of an event venue.

One exemplary system for event venue communication includes a plurality of recording devices located at a plurality of locations within a performance area of an event venue. The exemplary system also includes one or more local wireless transmitters, where each local wireless transmitter of the one or more local wireless transmitters transmits data within a wireless transmission zone near the local wireless transmitter, wherein each wireless transmission zone includes at least a portion of an eventgoer area of an event venue. The exemplary system also includes a transmission controller device. Execution of instructions stored in a memory of the a transmission controller device by a processor of a transmission controller device performs various system operations. The system operations include receiving a plurality of recorded datasets from the plurality of recording devices. The system operations also include combining the first plurality of recorded datasets into a first venue dataset. The system operations also include receiving one or more secondary venue datasets. The system operations also include receiving a selection input identifying a venue associated with a selected venue dataset, wherein the selected venue dataset is one of the first venue dataset or one of the one or more secondary venue datasets. The system operations also include transmitting at least a subset of the selected venue dataset wirelessly to one or more receiver devices using the one or more local wireless transmitters.

One exemplary non-transitory computer-readable storage medium is also described, the non-transitory computer-readable storage medium having embodied thereon a program executable by a processor to perform an exemplary program method for event venue communication that includes receiving a first plurality of recorded datasets from a plurality of recording devices located at a plurality of locations within a performance area of an event venue. The exemplary program method also includes combining the first plurality of recorded datasets into a first venue dataset. The exemplary program method also includes receiving one or more secondary venue datasets. The exemplary program method also includes receiving a selection input identifying a venue associated with a selected venue dataset, wherein the selected venue dataset is one of the first venue dataset or one of the one or more secondary venue datasets. The exemplary program method also includes transmitting at least a subset of the selected venue dataset wirelessly to one or more receiver devices using one or more local wireless transmitters, where each local wireless transmitter of the one or more local wireless transmitters transmits data within a wireless transmission zone near the local wireless transmitter, wherein each wireless transmission zone includes at least a portion of an eventgoer area of an event venue.

### BRIEF DESCRIPTION OF THE DRAWINGS

FIG. 1A illustrates an exemplary event timeline for an exemplary sporting event.

FIG. 1B illustrates an exemplary event venue ecosystem.

FIG. 2 illustrates exemplary data communications between one or more transmitters and an exemplary mobile device.

FIG. 3 illustrates an exemplary transmitter system.

FIG. 4A illustrates an exemplary beacon and beacon controller.

FIG. 4B is a flow diagram illustrating exemplary operations of the beacon software.

FIG. 5A illustrates an exemplary camera and camera controller.

FIG. 5B is a flow diagram illustrating exemplary operations of the camera software.

FIG. 6A illustrates an exemplary eventgoer activity selection.

FIG. 6B is a flow diagram illustrating exemplary operations of the eventgoer activity software

FIG. 7A illustrates an exemplary data source collector.

FIG. 7B is a flow diagram illustrating exemplary operations of the data feed router.

FIG. 8 illustrates an exemplary transmitter software graphical user interface and various transmitter system operations.

FIG. 9 illustrates an exemplary overall method of the present invention as described herein.

FIG. 10 is a block diagram of an exemplary computing device that may be used to implement an embodiment of the present invention.

### DETAILED DESCRIPTION

An event venue with a performance area (e.g., a stage, a sports field) and an eventgoer area (e.g., stadium seating, bleachers) may include beacons and cameras throughout the performance area and eventgoer area. The beacons and cameras may each record event occurrence data (e.g., images, audio, video) of particular occurrences (e.g., sport goals, songs played, eventgoer activities) during an event (e.g., sports game, concert) at the event venue. The beacons and cameras may send this event occurrence data to a transmission system, which may also receive similar event occurrence data from other event venues. The transmission system may convert selected event occurrence data from a first format to a second format, and then may output the event occurrence data in the second format through one or more local wireless transmitters. Eventgoers in the transmission zones of these transmitters may then receive the event occurrence data at their mobile devices.

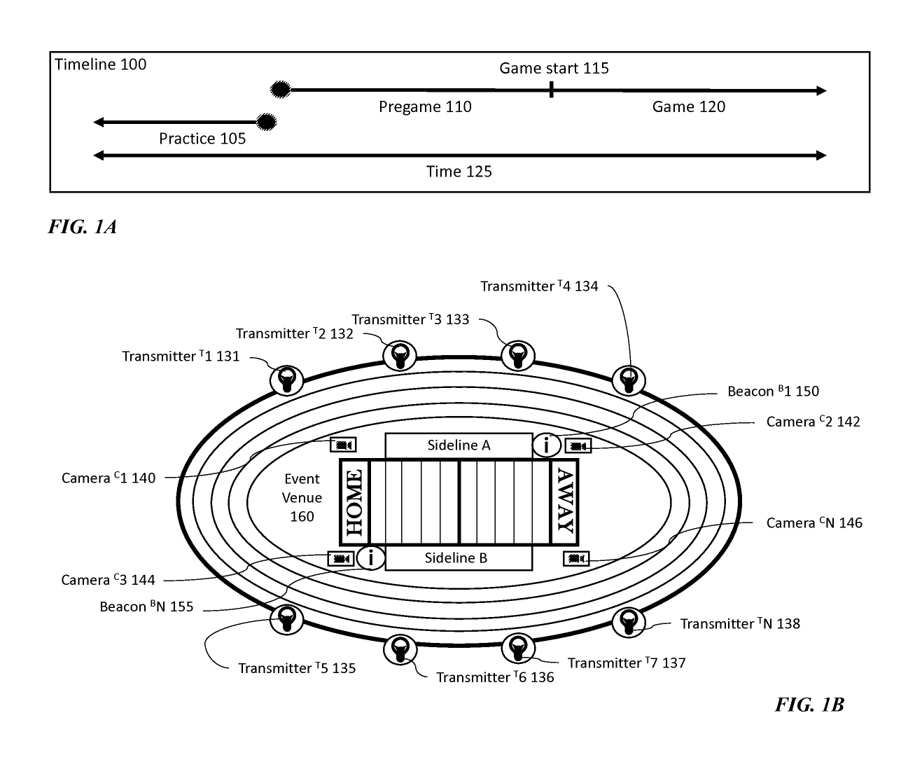

FIG. 1A illustrates an exemplary event timeline for an exemplary sporting event. The timeline 100 is a graphic representation of linear events (some of which may occur in parallel) over a period of time 125 that includes time intervals taking place before and during a sports event. The timeline 100 of FIG. 1A illustrates, for example, a warm-up practice 105, a pre-game show or ceremony 110, the start of the game 115, and the sports game 120 itself (e.g., which may take place both in a main play area, such as a field or court, an in a side “discussion” area, such as the sidelines). The pre-game show or ceremony 110 may include, for example, replayed highlights of previous games, or discussions about the players, or interviews with players.

The event timeline of a sports event also may also include other distinct time periods, such as a planned break in play (e.g., a half-time break or lunch break) or a planned end to the sport event.

Other types of events, such as concerts, may have other types of significant time periods, such as opening acts, intermissions, and a feature presentation/act.

FIG. 1B illustrates an exemplary event venue ecosystem.

The event venue is illustrated in FIG. 1B as a sport stadium, but may be any type of event venue used to host any type of event, public or private. For instance, the event venue may be a venue for any type of entertainment or cultural events that are presented at a theater, gymnasium, church, stadium, or other facility to a group of people. Such events include a wide variety of sporting events such as football (American and Global), baseball, basketball, soccer, ice hockey, lacrosse, rugby, cricket, tennis, track and field, golf, cycling, motor sports such as automobile or motorcycle racing, horse racing, Olympic games, and the like; cultural events such as concerts, music festivals, plays, or the opera, and the like; religious events; and more permanent exhibitions such as a museum, historic home, and the like.

The event venue ecosystem includes a number of transmitters 210, identified as transmitter T1 131, transmitter T2 132, transmitter T3 133, transmitter T4 134, transmitter T5 135, transmitter T6 136, transmitter T7 137, and transmitter TN 138.

Each transmitter of the transmitters 210 may be any type of information transmission system. For example, each transmitter may transmit information using a Wi-Fi connection module, a 3G/4G/LTE cellular connection module, a Bluetooth connection module, a Bluetooth low energy connection module, Bluetooth Smart connection module, a near field communication module, a radio wave communications module, a microwave communications module, a magnetic induction transmitter, a magnetic resonance transmitter, an electromagnetic radiation transmission module, a visible light communication (VLC) transmission lamp/laser/module, a laser transmission module, a speaker (e.g., audible sound transmitter, ultrasonic transmitter, infrasonic transmitter) with or without noise cancelling features, or some combination thereof. Each transmitter may include any number of sub-transmitters.

Each of the transmitters may emit a transmission through a substantially cone-shaped “transmission zone,” such as the transmission zone 220 of transmitter T1 131. All (or at least a subset of) mobile devices 210 located within such as transmission zone may receive a transmission sent by the transmitter. A transmitter may have a substantially cone-shaped transmission zone (e.g., as illustrated with respect to transmission zone 220), for example, if the transmitter T1 131 is a visible light communication (VLC) transmission lamp (e.g., a fluorescent lamp or incandescent lamp or light emitting diode emitting light at least partly within the visible light spectrum), which communicates information via light. A transmitter may also have a substantially cone-shaped transmission zone if, for example, the transmitter is a speaker, such as an audible-frequency speaker, an ultrasonic-frequency speaker, an infrasonic frequency speaker, or some combination thereof.

The transmitter can alternately have a differently-shaped transmission zone, such as a transmission zone that is at least partly sphere-shaped or ovoid-shaped. For example, the transmitter could be a local Bluetooth transmitter transmitting circularly around to surrounding recipient devices.

The transmitters 210 may be used inside of or otherwise associated with an event venue during an event. For example, the transmitters may be used during entertainment or cultural events that are presented at a theater, gymnasium, stadium, or other facility to a group of people. Such events include a wide variety of sporting events such as football (American and Global), baseball, basketball, soccer, ice hockey, lacrosse, rugby, cricket, tennis, track and field, golf, cycling, motor sports such as automobile or motorcycle racing, horse racing, Olympic games, and the like; cultural events such as concerts, music festivals, plays, or the opera, and the like; religious events; and more permanent exhibitions such as a museum, historic home, and the like.

The event venue ecosystem also includes a number of cameras, identified as camera C1 140, camera C2 142, camera C3 144, and camera CN 146. The cameras may be any type of cameras, and may record and output image data, video data, or some combination thereof. The cameras may also include (or in some cases, may be replaced with) microphones to record and output audio data. The cameras may be positioned to record occurrences within the performance area of the event venue (e.g. the field, the court, the play area, the stage) as well as a “side” performance area (e.g., the sidelines, backstage).

The cameras may be used to record, for example, specific gameplay occurrences during play of a sport event (e.g., a particular play, a particular goal, a particular pass, a particular steal, a particular touchdown, a particular foul, a particular fumble) out of play of a sporting event (e.g., a play-break team huddle, a locker room team discussion, a water cooler team discussion). The cameras may be used to record other event occurrences, such a music artist performing during a concert (and/or discussing backstage before/after the concert), an acting performance (and/or a dress rehearsal before or interviews before/after), a lecture, a religious event, or any other type of performance that might take place in a particular event venue with eventgoers.

The cameras may use a variety of recording technologies, and may record any band of electromagnetic frequencies. For example, the cameras may record visible light, thermal (e.g., infrared), microwave, radio, or ultraviolet frequencies. The cameras may use low-light or night vision technologies for nighttime events. The cameras may record using magnetic tapes, optical disks, or any type of computer-associated memory or storage systems, such as a memory 1020, mass storage device 1030, or portable storage device 1040.

The event venue ecosystem also includes a number of beacons, identified as beacon B1 150 and beacon BN 155.

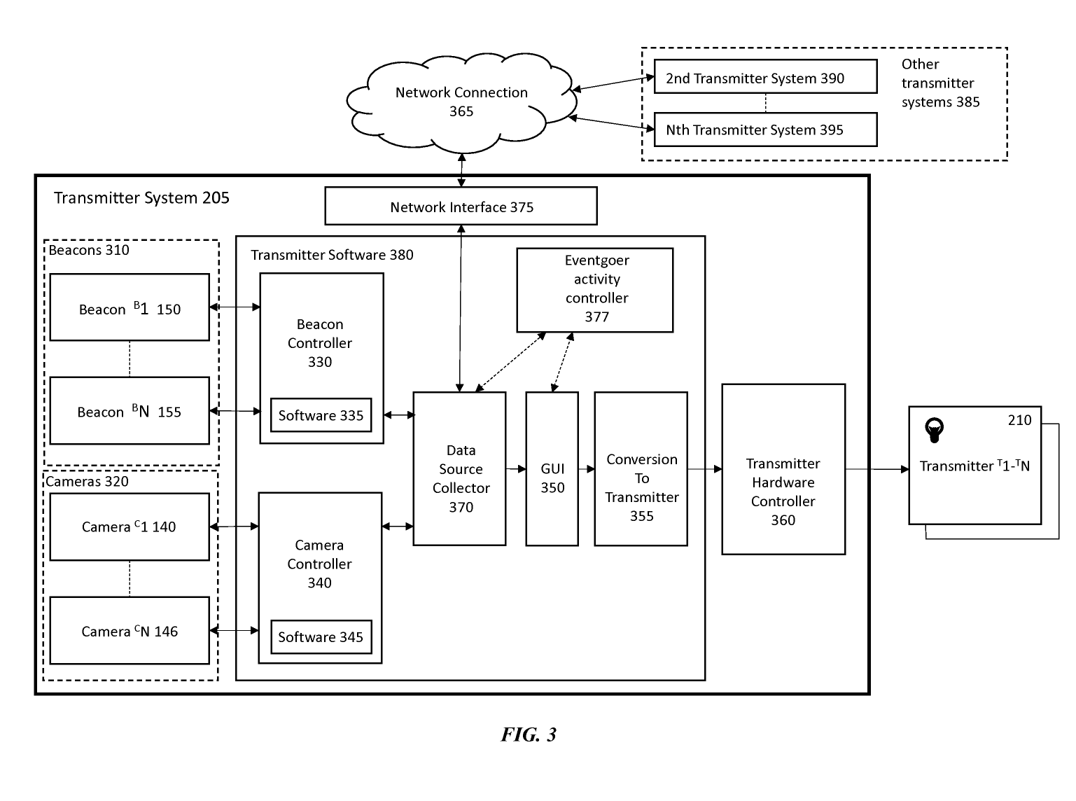

The beacons of FIG. 1B may be used to transfer audio and video data from the performance area of the event venue to the transmitters 210. For example, the cameras may be communicatively coupled to the beacons, so that once the cameras record an event occurrence, data (e.g., images, video, or audio) pertaining to the event occurrence, the data can be sent to the transmitters 210, where it can be transmitted to eventgoer mobile devices 220. Each beacon may be associated with one or more of the cameras, or may be independent of any of the cameras illustrated in FIG. 1B. Each beacon may include its own cameras and/or microphones. The beacons may include wireless transmitters and/or wired transmitters that may be used to send any audio/video that is recorded by or received by the beacon to a transmitter system 205 running a transmitter software 380 with a graphical user interface (GUI) 350 (e.g., see FIG. 3).

The beacons may include wireless connectivity functionality, such as a Wi-Fi connection module, a 3G/4G/LTE cellular connection module, a Bluetooth connection module, a Bluetooth low energy connection module, Bluetooth Smart connection module, a near field communication module, a radio wave communications module, a microwave communications module, a magnetic induction transmitter, a magnetic resonance power transmitter, an electromagnetic transmission module, a visible light communication (VLC) transmission module, a laser transmission module, an ultrasonic transmission module, an infrasonic transmission module, or some combination thereof. The beacons may include wired connectivity functionality, such as a Universal Serial Bus (USB) port, a FireWire port, an Ethernet port, a modem port, a fiber optic cable port, a Lightning port, a Thunderbolt port, customized audio jack port, or a proprietary data transfer cable port.

During the pre-game time period 110, the beacons may gather pre-game sideline data, which may include, for example, injury reports detailing the extent of how various players are injured. During the in-game time period 120, the beacons may also gather in-game sideline data, which may for example include back-up reports identifying backup players.

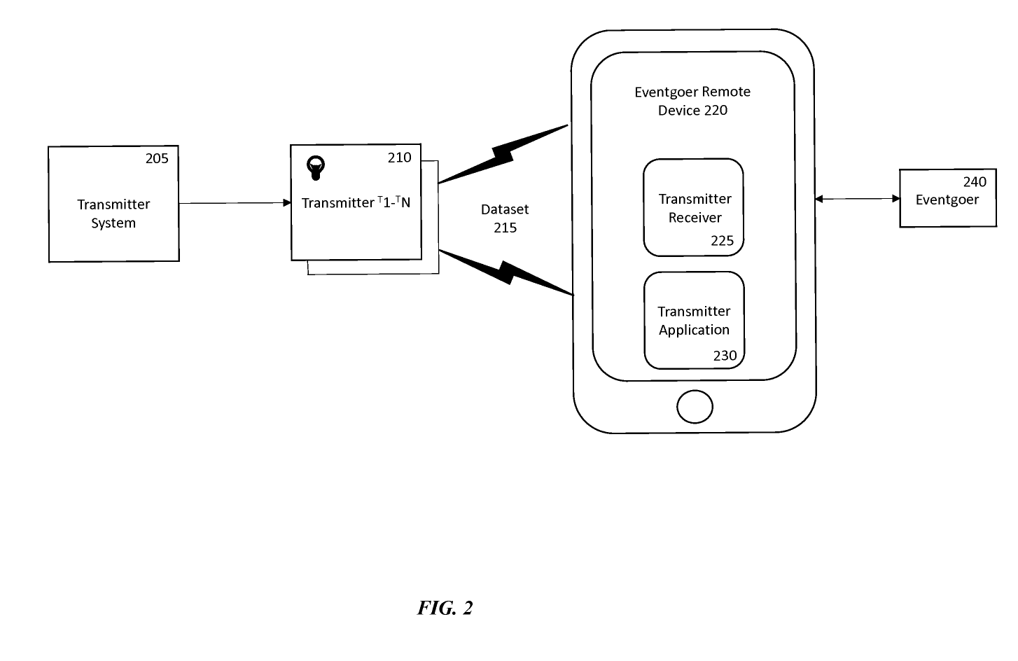

FIG. 2 illustrates exemplary data communications between one or more transmitters and an exemplary mobile device.

In particular, the communications of FIG. 2 begin with the transmitter system 205. At the communication stage illustrated in FIG. 2, a particular dataset 215 (e.g., including images, recorded audio, streaming/live audio, recorded video, streaming/live video, and/or text) has already been chosen at the transmitter system 205 (e.g., automatically via software executed by the transmitter system 205 or manually by an administrator using a graphical user interface 350 executed at the transmitter system 205 as illustrated in FIG. 3) to transmit via one or more of the transmitters 210. Similarly, the particular transmitters that will be used to transmit the dataset 215 may have already been chosen and identified to the transmitter system 205 (e.g., using the graphical user interface 350), or the transmitter system 205 may automatically determine the best transmitter(s) to use for a particular dataset 215. For example, the transmitter system 205 may select transmitters whose transmission zones are farthest away from a particular event occurrence depicted in a video included in the dataset 215 (e.g., a sports foul) so that faraway eventgoers can have a good view of the event occurrence despite being far away from it.

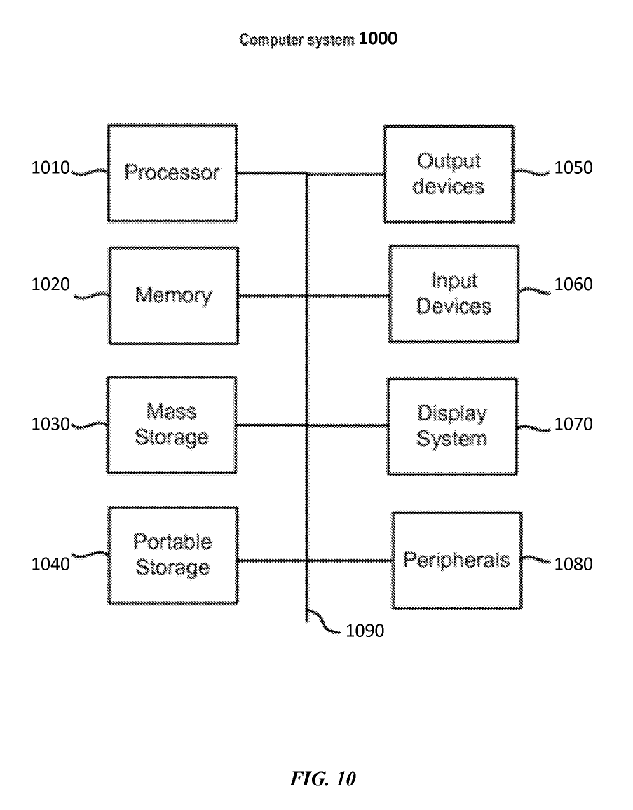

The mobile device 220 of FIG. 2 may be associated with one of the eventgoers 240 who may be located in an eventgoer area (e.g., stadium seating, bleachers, theater seating, or a standing room eventgoer area) of the event venue of FIG. 1B, or of a different type of event venue. The mobile device 220 may be any type of computing device, such as the computing device 1000 of FIG. 10. The mobile device 220 may be, for example, a smartphone, a tablet device, a wearable device (e.g., a smart watch, a smart bracelet/jewelry, or smart glasses), a laptop computer, a portable video game console, a portable e-reader device, or a portable media player device.

The mobile device 220 may include a transmission detector 225. The transmission detector 225 may include, for example, the ability to receive information using a Wi-Fi connection module, a 3G/4G/LTE cellular connection module, a Bluetooth connection module, a Bluetooth low energy connection module, Bluetooth Smart connection module, a near field communication module, a radio wave communications module, a microwave communications module, a magnetic induction receiver, a magnetic resonance receiver, an electromagnetic radiation receiver module, a visible light communication (VLC) receiver module, a laser transmission receiver module, a microphone (e.g., audible sound receiver, ultrasonic receiver, infrasonic receiver) with or without noise cancelling features, or some combination thereof. The transmission detector 225 may include any number of sub-receivers. The transmission detector 225 in particular may be configured to be able to receive and/or decode at least a dataset 215 sent by one or more of the transmitters 210.

The mobile device 220 may also include a display (not labeled), which may be any type of display system 1070 described in FIG. 10.

The mobile device 220 may also include a transmitter software app 230 through which the information transmitted from the transmitters 210 (e.g. advertisements and/or queue information) may be displayed by the mobile device 220. The transmitter software app 230 may be an operating system, or it may alternately be a more specialized software application, such as a social media platform software application, a news reader application, a feed reader application, an email reader application, or a message reader application.

FIG. 3 illustrates an exemplary transmitter system.

In particular, the transmitter system 205 of FIG. 3 includes a set of beacons 310 (e.g. including beacon B1 150 through beacon BN 155) connected to a beacon controller 330. The beacon controller 330 is a controller subsystem for controlling the beacons 310 and receiving beacon data from the beacons 310. The beacon controller 330 may be a software routine of the transmitter software 380, may be a separate computer system 1000, or some combination thereof. Either way, the beacon controller 330 may be associated with a wired or wireless communication module (not shown) capable of receiving data transmissions directly from one or more of the beacons 310. The beacon controller 330 may include or be associated with a processor (which may be any kind of processor 1010), which may execute a beacon software 335 stored in a memory/storage (e.g., a memory 1020, a mass storage 1030, or a portable storage 1040) associated with the beacon controller 330 and/or the transmitter system 205. The beacon software 335 may be used to support various functions of the beacon controller 330 (e.g., the beacon software 335 may include beacon connection software drivers).

The transmitter system 205 of FIG. 3 also includes a set of cameras 320 (e.g. including camera C1 140 through camera CN 146) connected to a camera controller 340. The camera controller 340 is a controller subsystem for controlling the cameras 320 and receiving camera data from the cameras 320. The camera controller 340 may be a software routine of the transmitter software 380, may be a separate computer system 1000, or some combination thereof. Either way, the beacon controller 330 may be associated with a wired or wireless communication module (not shown) capable of receiving data transmissions directly from one or more of the cameras 320. The camera controller 340 may include or be associated with a processor (which may be any kind of processor 1010), which may execute a camera software 345 stored in a memory/storage (e.g., a memory 1020, a mass storage 1030, or a portable storage 1040) associated with the camera controller 340 and/or the transmitter system 205. The camera software 345 may be used to support various functions of the camera controller 340 (e.g., the camera software 345 may include camera connection software drivers).

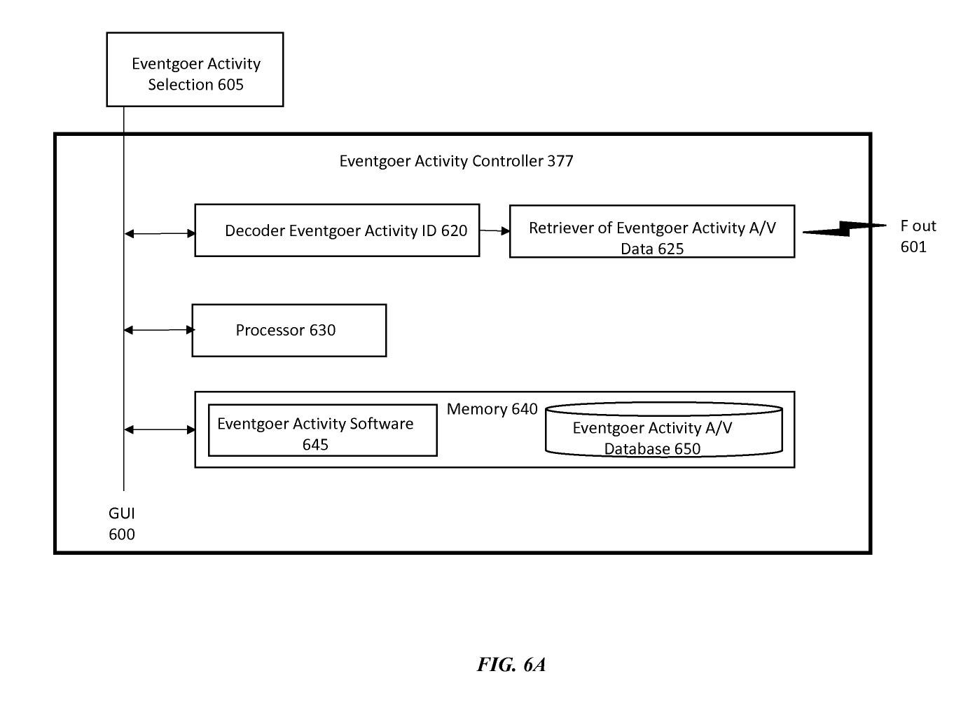

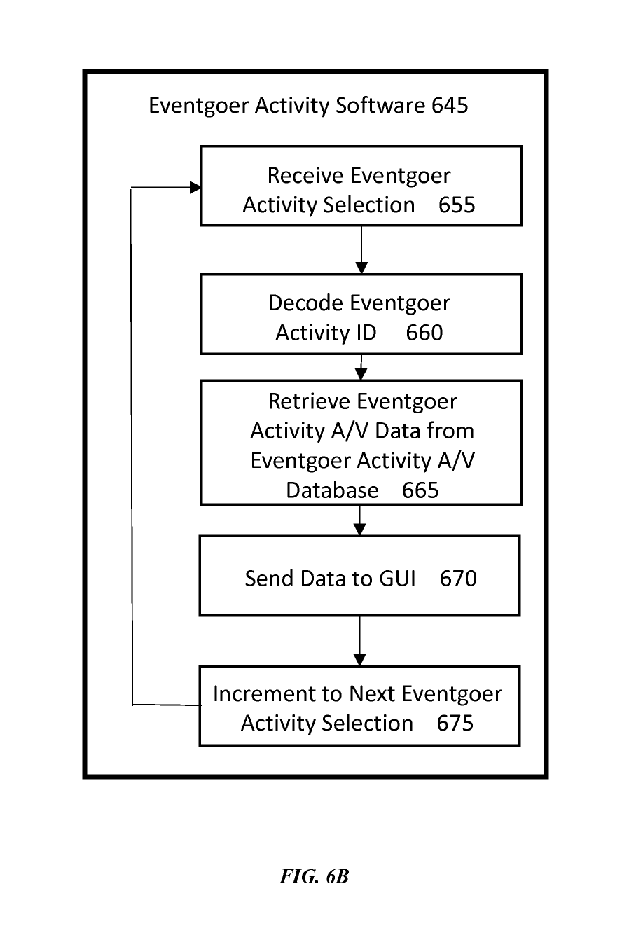

The transmitter system 205 of FIG. 3, and in particular the transmitter software 308, also includes a data source collector 370, which receives data from the beacon controller 330 and the camera controller 340 as inputs. The data source collector 370 also receives data from a set of other transmitter systems 385 (e.g., including a second transmitter system 390 through an Nth transmitter system 395) through a network connection 365 that the transmitter system 205 is connected to via a wired or wireless network interface 375. The data source collector 370 may also receive data from an eventgoer activity controller 377, illustrated further in FIG. 6A. The network connection 365 may be a connection through the public Internet, or may alternately be a connection through one or more private networks, which may include a local area network (LAN), a wireless local area network (WLAN), a municipal area network (MAN), a wide area network (WAN), or some combination thereof.

The transmitter system 205 of FIG. 3, and in particular the transmitter software 308, also includes a graphical user interface (GUI) 350, which receives data from the data source collector 370 (e.g., which may itself include data from the beacon controller 330 , from the camera controller 340 , and from the other transmitter systems via the network interface 375) as an input. The graphical user interface (GUI) 350 may also receive data from an eventgoer activity controller 377, illustrated further in FIG. 6A. The GUI 350 may be accessed by an administrative user associated with the event venue, the transmitters, the beacons, the cameras, the event organizers (e.g., sponsors, sports associations, sports teams, concert organizers, educational administrative groups, church administrative groups), the performers (e.g., the sports teams, musical artists, lecturers, speakers). The GUI 350 may be used to select a dataset 215 (e.g., a particular set of data including images, recorded audio, streaming/live audio, recorded video, streaming/live video, and/or text) from the beacons 310 and/or from the cameras 320 that should be transmitted to eventgoer mobile devices 220 as illustrated in FIG. 2. The GUI 350 may also be used to select at least a subset including one or more transmitters (e.g., transmitter T2 132 and transmitter T6 136) of the set of transmitters 210 (which includes, in the event venue example of FIG. 1B, transmitter T1 131 through transmitter TN 136) through which the identified dataset 215 should be transmitted. In some cases, all of the transmitters 210 may be selected.

In an alternate embodiment (not shown), the dataset 215 may be selected by a software routine of the transmitter system 205 and transmitter software 380. For example, if the software detects that a ball, puck, Frisbee, or person has entered a “goal” or “touchdown” area, a dataset 215 may automatically be generated including video/audio/images of this occurrence. Similarly, the software routine of the transmitter system 205 and transmitter software 380 may automatically select at least a subset of the transmitters 210 over which to broadcast a particular dataset 215, for example by selecting transmitters with transmission zones nearest the location of the event occurrence, transmitters with transmission zones farthest from the location of the event occurrence, all transmitters, or randomly selected transmitters.

Once the dataset 215 is identified (e.g., either manually at the GUI 350 or automatically by a software routine of the transmitter system 205), and the transmitters to transmit the dataset 215 have been selected (e.g., either manually at the GUI 350 or automatically by a software routine of the transmitter system 205), the dataset 215 is optionally passed through a conversion algorithm 355, which may convert the dataset 215 to a format which may be transmitted by one or more of the transmitters 210. The dataset 215 (converted or not) may then be sent to a transmitter hardware controller 360, which then directs the dataset 215 (converted or not) to the individual identified transmitters of the set of transmitters 210 through which it is to be transmitted.

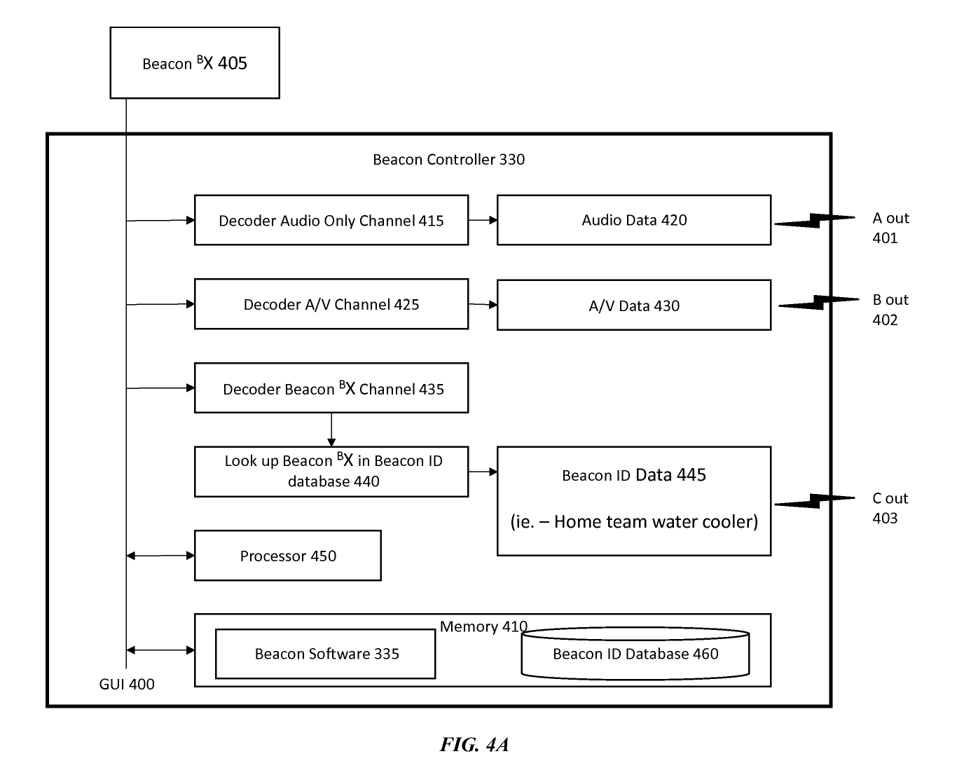

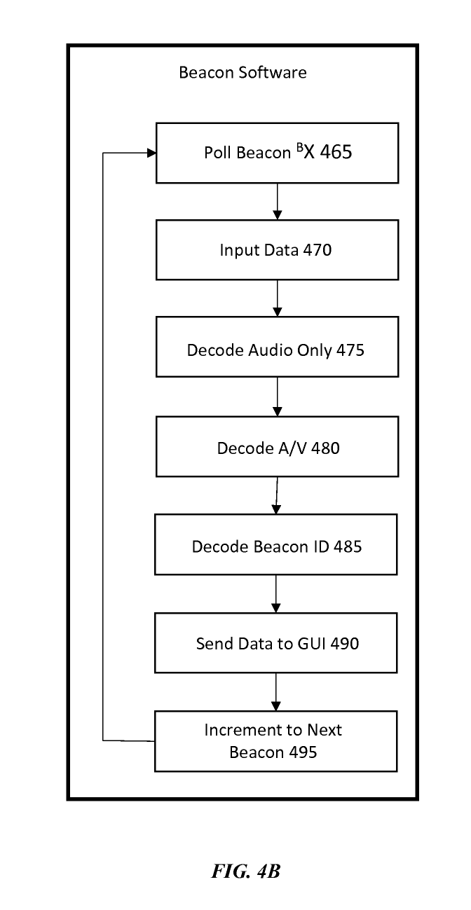

FIG. 4A illustrates an exemplary beacon and beacon controller.

The exemplary beacon BX 405 (e.g., one of the beacons B1 150 to BN 155) is communicatively coupled (e.g., in a wired or wireless manner) to the beacon controller 330. The beacon controller 330 includes an audio-only-channel decoder 415, which is a beacon channel decoder that reads audio data from one or more microphones of the beacon BX 405 and outputs audio data 420. The beacon controller 330 includes an audiovisual-channel decoder 425 (“A/V” channel decoder 425), which is a beacon channel decoder that reads audio data, visual data, or some combination thereof (e.g., a video with sound) from one or more cameras and/or microphones of the beacon 405 and outputs A/V data 430.

The beacon controller 330 also includes a Beacon BX channel decoder 435, which can identify which beacon of a set of beacons 310 is transmitting data to the beacon controller 330. Such operations may include a lookup operation 440, which includes looking up an identifying element of data from the beacon 405 to identify the beacon BX 405 in a beacon identifier (“beacon ID”) database 460. The beacon controller 330 can then output specific beacon identifier information 445, which may for example identify a type and/or location of the beacon (e.g., home team water cooler beacon located at or near the home team's water cooler).

The beacon controller 330 may also include a processor 450 (which may be any kind of processor 1010) and a memory 410 (which may be a memory 1020, a mass storage 1030, a portable storage 1040, or some combination thereof). The memory 410 may include the beacon software 335 and the beacon identifier (“beacon ID”) database 460. The beacon controller 330 may further store and execute a GUI 400, which may include the GUI 350 of the transmitter software, may be a sub-GUI of the GUI 350, or and may be a separate GUI from the GUI 350 that includes beacon-specific GUI elements.

FIG. 4B is a flow diagram illustrating exemplary operations of the beacon software.

At step 465, the beacon software 335 may begin by polling a beacon BX 405 (e.g., this may start with first beacon B1 150) to see if the beacon BX 405 has produced any data and/or sent any data to the beacon controller 330. At step 470, any data input sent by the beacon is received. At step 475, the beacon software 335 decodes the audio data channel of the beacon's received input data to produce audio data. At step 480, the beacon software 335 decodes the audiovisual data channel of the beacon's received input data to produce audio data, visual data, or some combination thereof. At step 485, the beacon software 335 decodes a beacon identifier from the beacon's received input data and identifies the beacon. At step 490, the beacon software 335 sends any data decoded from the beacon's received input data to the GUI 350 (and optionally to the GUI 400). At step 495, the beacon software 335 performs the beacon software operations again for the incrementally next beacon, starting from step 465.

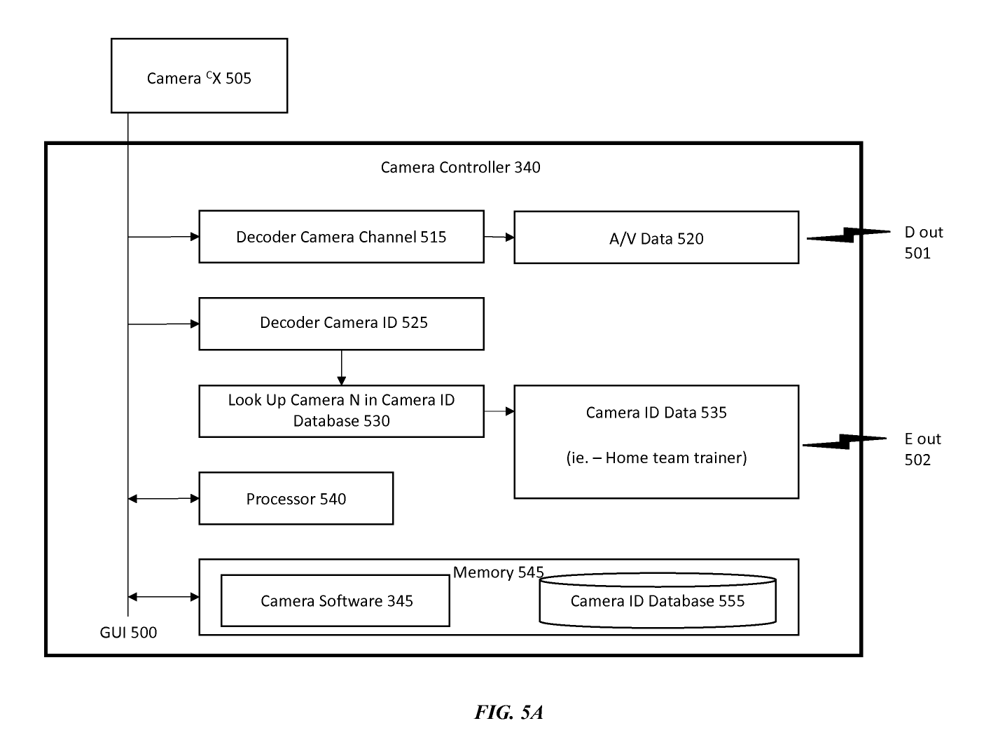

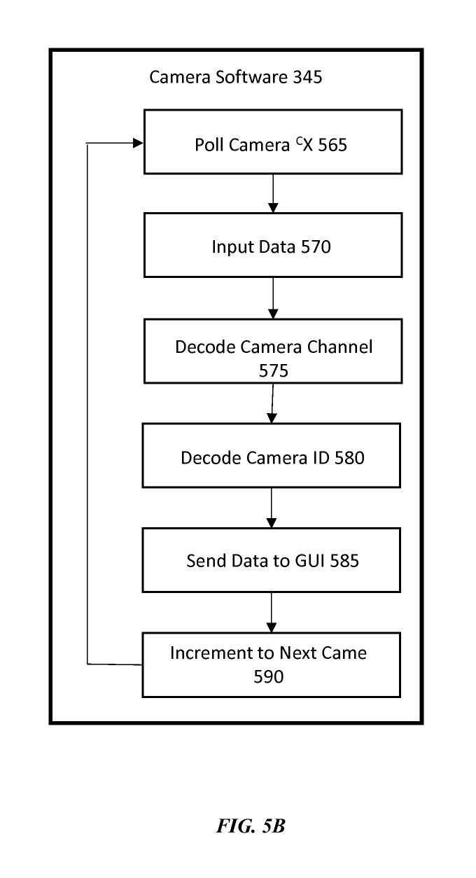

FIG. 5A illustrates an exemplary camera and camera controller.

The exemplary camera CX 505 (e.g., one of the cameras C1 140 to CN 146) is communicatively coupled (e.g., in a wired or wireless manner) to the camera controller 340. The camera controller 340 includes an camera-channel decoder 515, which is a camera channel decoder that reads audio data, visual data, or some combination thereof (e.g., images, video, video with sound) from one or more cameras and/or microphones of the camera CX 505 and outputs A/V data 520.

The camera controller 340 also includes a Camera Identifier (“ID”) channel decoder 525, which can identify which camera of a set of cameras 320 is transmitting data to the camera controller 340. Such operations may include a lookup operation 530, which includes looking up an identifying element of data from the camera 505 to identify the camera CX 505 in a camera identifier (“camera ID”) database 555. The camera controller 340 can then output specific camera identifier information 535, which may for example identify a type and/or location of the camera (e.g., home team trainer camera following the home team's trainer).

The camera controller 340 may also include a processor 540 (which may be any kind of processor 1010) and a memory 545 (which may be a memory 1020, a mass storage 1030, a portable storage 1040, or some combination thereof). The memory 545 may include the camera software 345 and the camera identifier (“camera ID”) database 555. The camera controller 340 may further store and execute a GUI 500, which may include the GUI 350 of the transmitter software, may be a sub-GUI of the GUI 350, or and may be a separate GUI from the GUI 350 that includes camera-specific GUI elements.

FIG. 5B is a flow diagram illustrating exemplary operations of the camera software.

At step 565, the camera software 345 may begin by polling a camera CX 505 (e.g., this may start with first camera C1 140) to see if the camera CX 505 has produced any data and/or sent any data to the camera controller 340. At step 570, any data input sent by the camera CX 505 is received. At step 575, the camera software 345 decodes the camera data channel of the camera's received input data to produce audio data, visual data, or some combination thereof. At step 580, the camera software 345 decodes a camera identifier from the camera's received input data and identifies the camera. At step 585, the camera software 345 sends any data decoded from the camera's received input data to the GUI 350 (and optionally to the GUI 500). At step 590, the camera software 345 performs the camera software operations again for the incrementally next camera, starting from step 565.

FIG. 6A illustrates an exemplary eventgoer activity selection.

An eventgoer activity selection 605 may identify a particular eventgoer activity, such as a chant to be performed by eventgoers, a cheer to be performed by eventgoers, a song to be sung by eventgoers (e.g., a sports team fight song), a dance to be performed by eventgoers, a motion to be performed by eventgoers (e.g., the “wave”), or another activity or action to be performed by eventgoers. The eventgoer activity identified by the eventgoer activity selection 605 may be previously determined, selected, and/or coordinated by event staff (e.g., an event venue owner or administrator, an announcer) or performer staff (e.g., staff of a concert artist, staff of a sports team, cheerleaders of a sports team, or staff of a sports administrative body). The eventgoer activity selection 605 may be identified at an eventgoer activity controller 377.

The eventgoer activity controller 377 may include a variety of hardware and software components, which may perform a variety of operations, and which may include a computer system 1000 as illustrated in FIG. 10. The eventgoer activity controller 377 may include a decoder for an eventgoer activity identifier 620, which can identify an eventgoer activity identified in the eventgoer activity selection 605 according to an identifier (e.g., an alphanumeric code), which may be matched against a predetermined list (e.g., or database or other data structure) of eventgoer activities and corresponding known identifiers. The eventgoer activity controller 377 can then retrieve eventgoer activity audiovisual data (e.g., from an eventgoer activity audiovisual database 650) using a retriever 625. The retrieved eventgoer activity audiovisual data may include recorded media depicting the eventgoer activity identified in the eventgoer activity selection via recorded video, photographs, audio, or some combination thereof.

The eventgoer activity controller 377 may also include a processor 630 (which may be any kind of processor 1010) and a memory 640 (which may be a memory 1020, a mass storage 1030, a portable storage 1040, or some combination thereof). The memory 640 may include the eventgoer activity software 645 (described further in FIG. 6B) and the eventgoer activity audiovisual database 650, which may store identified eventgoer activities and/or corresponding identifiers, and may also store recorded media depicting the eventgoer activity identified in the eventgoer activity selection via recorded video, photographs, audio, or some combination thereof. The eventgoer activity controller 377 may further store and execute a GUI 600, which may include the GUI 350 of the transmitter software, may be a sub-GUI of the GUI 350, or and may be a separate GUI from the GUI 350 that includes eventgoer-activity-specific GUI elements.

FIG. 6B is a flow diagram illustrating exemplary operations of the eventgoer activity software. At step 655, the eventgoer activity software 645 may receive the eventgoer activity selection 605. At step 660, the eventgoer activity software 645 may decode the eventgoer activity identifier associated with the eventgoer activity software 645 (e.g., using the decoder 620). At step 665, the eventgoer activity software 645 may then retrieve eventgoer activity audiovisual data from the eventgoer activity audiovisual database 650 (e.g., using the retriever 625). The retrieved eventgoer activity audiovisual data of step 665 may include recorded media depicting the eventgoer activity identified in the eventgoer activity selection via recorded video, photographs, audio, or some combination thereof. At step 670, the retrieved eventgoer activity audiovisual data of step 665 is sent to the GUI 600 and/or the GUI 350. At step 675, the operations of the eventgoer activity software 645 increment to the next eventgoer activity selection 605 and begin again at step 655.

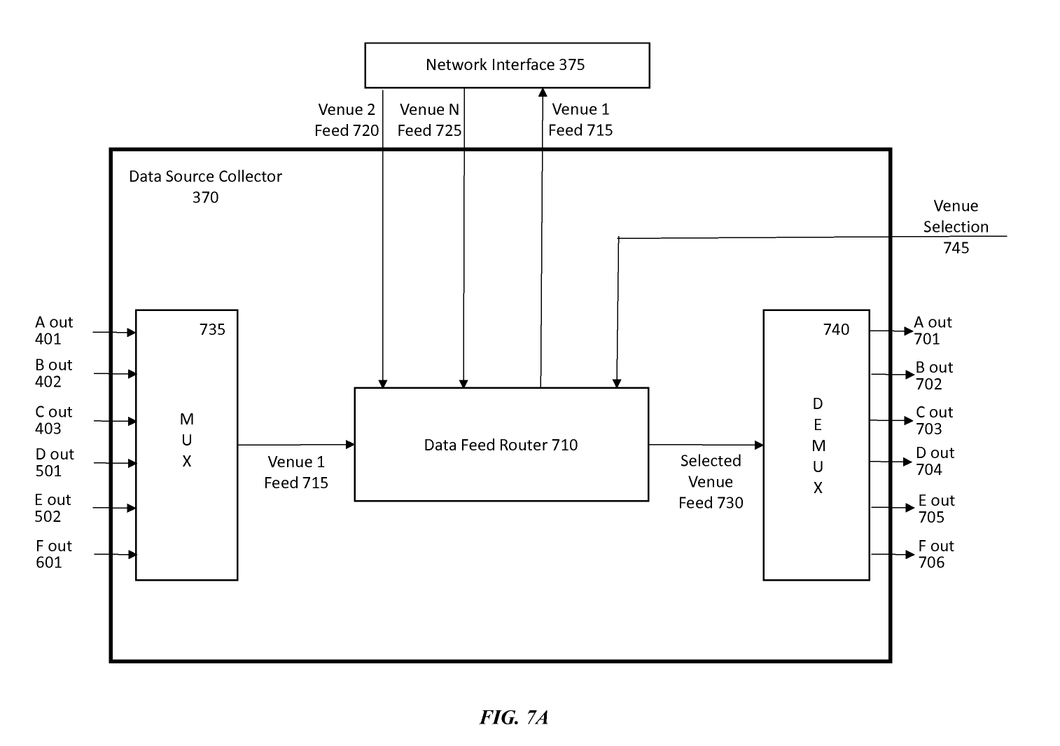

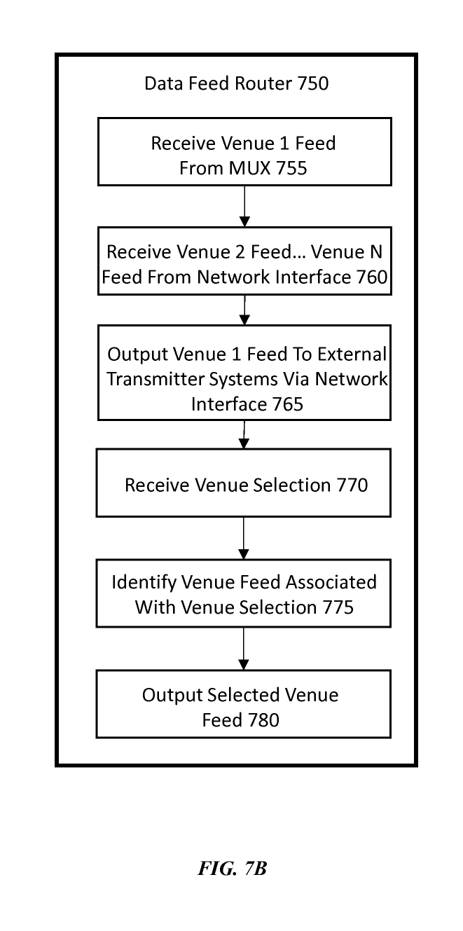

FIG. 7A illustrates an exemplary data source collector.

The data source collector 370 receives inputs from the beacon controller 330 (e.g., A out 401, B out 402, C out 403), from the camera controller 340 (e.g., D out 501, E out 502), and from the eventgoer activity controller 377 (e.g., F out 601). The data source collector 370 may then use a multiplexer 735 (“mux”) (which may in some cases include many sub-multiplexers) to forward all of these inputs to a single data feed that is identified as the venue 1 feed 715. A data feed router 710 may then receive feeds from other venues via the network interface 375, such as venue 2 (e.g., Venue 2 Feed 720) or venue N (e.g., Venue N Feed 725). The data feed router 710 may also send the venue 1 feed 715 to other venues via the network interface 375.

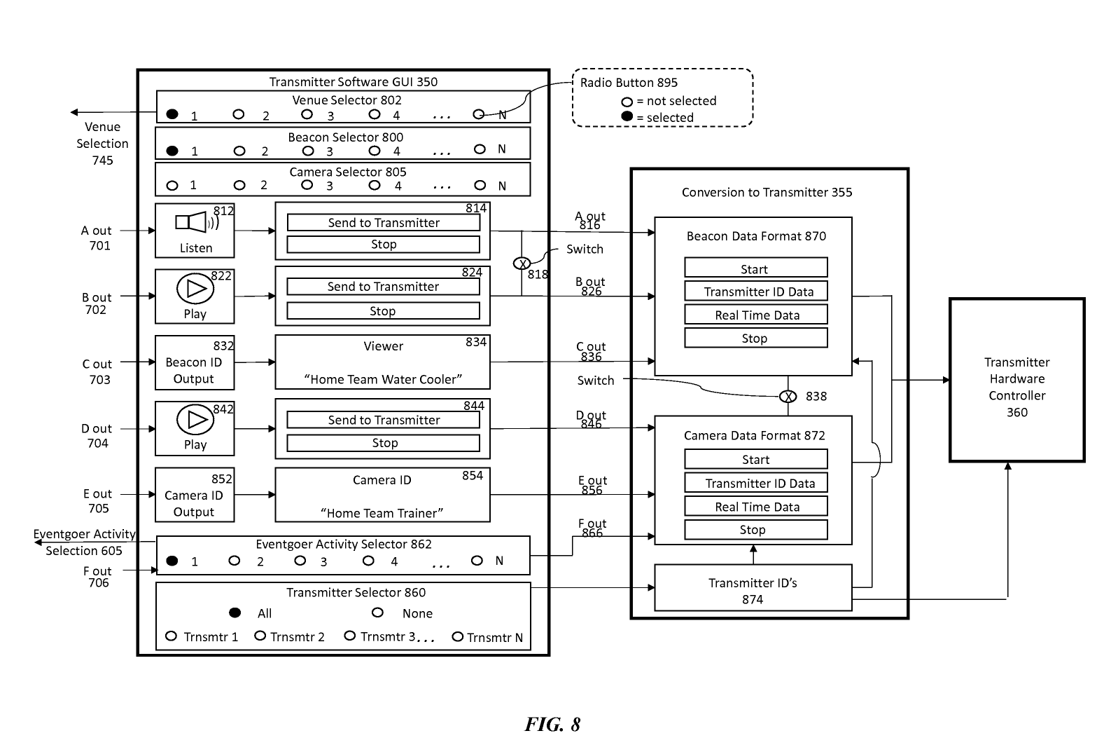

The data feed router 710 may then receive a venue selection 745 from the transmitter software GUI 350 (e.g., see FIG. 8). The venue selection 745 may identify a particular event venue, such as event venue 1, event venue 2, event venue 3, event venue 4, or other event venues up to and including an event venue N.

Once the venue selection 745 is received by the data feed router 710, the data feed router may then output a selected venue feed 730 corresponding to the selected event venue identified by the venue selection 745. A demultiplexer 740 (“demux”) (which may in some cases include many sub-demultiplexers) may then be used to break the selected venue feed 730 into multiple output feeds (e.g., A out 701, B out 702, C out 703, D out 704, E out 705, F out 706).

In cases where venue selection 745 identifies Venue 1, the selected venue feed 730 is the Venue 1 feed 715. As such, A out 701 is A out 401, B out 702 is B out 402, C out 703 is C out 403, D out 704 is D out 501, E out 705 is E out 502, and F out 706 is F out 601. In cases where venue selection 745 identifies Venue 2, the selected venue feed 730 is the Venue 2 feed 720. In cases where venue selection 745 identifies Venue N, the selected venue feed 730 is the Venue N feed 725.

FIG. 7B is a flow diagram illustrating exemplary operations of the data feed router.

At step 755, the data feed router 750 receives the Venue 1 feed 715, which includes data from various feeds (e.g., A out 701, B out 702, C out 703, D out 704, E out 705, F out 706) combined via multiplexer 735. At step 760, the data feed router 750 receives the Venue 2 feed 720 and the venue feeds of any other venues up to the Venue N feed 725. At step 765, the data feed router 750 outputs the Venue 1 feed to external transmitter systems (e.g., at other venues such as Venue 2, Venue 3, Venue 4, . . . Venue N) via the network interface 375.

At step 770, the data feed router 750 receives a venue selection 745 from the transmitter software GUI 350. At step 775, the data feed router 750 then identifies the venue feed associated with the venue selection 745 as the selected venue feed 730. At step 780, the data feed router 750 outputs the selected venue feed 730, during which it may pass through a demultiplexer 740 to be split into component data streams (e.g., beacon audio, beacon audiovisual, beacon identifier, camera audiovisual, camera identifier, eventgoer activity audiovisual).

FIG. 8 illustrates an exemplary transmitter software graphical user interface and various transmitter system operations.

The transmitter software GUI 350 of FIG. 8 includes various GUI elements. In particular, the transmitter software GUI 350 of FIG. 8 includes a venue selector 802, which allows a user to make a venue selection 745 to be fed to the data feed router of the data source collector 370 as illustrated in FIG. 7, using a radio button interface 895 (venue 1 is currently selected in FIG. 8). The transmitter software GUI 350 of FIG. 8 also includes a beacon selector 800, which allows a user to select one or more of the beacons 310 to receive data from using a radio button interface 895 (beacon B1 is currently selected in FIG. 8). The transmitter software GUI 350 of FIG. 8 also includes a camera selector 805, which allows a user to select one or more of the cameras 320 to receive data from using a radio button interface 895 (camera C1 is currently selected in FIG. 8). The transmitter software GUI 350 of FIG. 8 also includes a transmitter selector 860, which allows a user to select one or more of the transmitters 210 to receive data (e.g., beacon audio, beacon audiovisual, beacon identifier, camera audiovisual, camera identifier, eventgoer activity audiovisual, data from other venues, or some combination thereof) using a radio button interface 895 (all transmitters are currently selected in FIG. 8). The transmitter software GUI 350 of FIG. 8 also includes an eventgoer activity selector 862, which allows a user to select one or more eventgoer activities (e.g., a chant to be performed by eventgoers, a cheer to be performed by eventgoers, a song to be sung by eventgoers, a dance to be performed by eventgoers, a motion to be performed by eventgoers), to be output as the eventgoer activity selection 605 (see FIG. 6), using a radio button interface 895 (an eventgoer activity 1 is currently selected in FIG. 8). The radio button interfaces 895 may be replaced with other types of selection interfaces, such as checkbox interfaces, or text-selection based interfaces, or image or grid selection based interfaces, for example.

The transmitter software GUI 350 may receive a beacon audio output (“A out”) 701 from a beacon or beacon controller 330. The GUI 350 may allow the user to listen to the beacon audio output (“A out”) 701 through an audio-playing interface 812. A sending interface 814 then allows the user to choose to send the audio from the beacon audio output (“A out”) 701 to the transmitter(s) selected using the transmitter selector 860 (e.g., all transmitters according to the current selection in interface 860 of FIG. 8), or to stop transmission. If the audio is selected for transmission, it is sent to the “conversion to transmitter” operations 355 as a beacon audio output (“A out”) 816 to convert from a beacon data format 870 to a transmitter type format before being sent to transmitter hardware controller 360.

The transmitter software GUI 350 may receive an beacon audiovisual output (“B out”) 702 (audio, images, video, or some combination thereof) from a beacon or beacon controller 330. The GUI 350 may allow the user to play back to the beacon audiovisual output (“B out”) 702 through an audiovisual-playing interface 822. A sending interface 824 then allows the user to choose to send the audiovisual data from the beacon audiovisual output (“B out”) 702 to the transmitter(s) selected using the transmitter selector 860 (e.g., all transmitters according to the current selection in interface 860 of FIG. 8), or to stop transmission. If the audiovisual data is selected for transmission, it is sent to the “conversion to transmitter” operations 355 as a beacon audiovisual data output (“B out”) 826 to convert from a beacon data format 870 to a transmitter type format before being sent to transmitter hardware controller 360.

The transmitter software GUI 350 may receive at least one beacon identifier output (“C out”) 703, which may be checked at an interface 832. A sending interface 834 may in some cases allow a user to select whether the beacon ID is sent to the transmitter, though in some cases it is sent automatically, or in other cases, it is not sent at all. If the beacon ID is to be sent to the transmitter, it is sent as a beacon ID output (“C out”) 836 and may pass through the “conversion to transmitter” operations 355 to convert from a beacon data format 870 to a transmitter type format before being sent to transmitter hardware controller 360.

The transmitter software GUI 350 may receive an camera audiovisual output (“D out”) 704 (audio, images, video, or some combination thereof) from a camera or camera controller 340. The GUI 350 may allow the user to play back to the camera audiovisual output (“D out”) 704 through an audiovisual-playing interface 842. A sending interface 844 then allows the user to choose to send the audiovisual data from the camera audiovisual output (“D out”) 704 to the transmitter(s) selected using the transmitter selector 860 (e.g., all transmitters according to the current selection in interface 860 of FIG. 8), or to stop transmission. If the camera audiovisual output is to be sent to the transmitter, it is sent as a camera audiovisual output (“D out”) 846 and may pass through the “conversion to transmitter” operations 355 to convert from a camera data format 870 to a transmitter type format before being sent to transmitter hardware controller 360.

The transmitter software GUI 350 may receive at least one camera identifier output (“E out”) 705, which may be checked at an interface 852. A sending interface 854 may in some cases allow a user to select whether the camera ID is sent to the transmitter, though in some cases it is sent automatically, or in other cases, it is not sent at all. If the camera ID is to be sent to the transmitter, it is sent as a camera ID output (“E out”) 856 and may pass through the “conversion to transmitter” operations 355 to convert from a camera data format 870 to a transmitter type format before being sent to transmitter hardware controller 360.

The transmitter software GUI 350 may receive at least one eventgoer activity audiovisual output (“F out”) 706. The eventgoer activity audiovisual output (“F out”) 706 may optionally be identified at the eventgoer activity selector 862, or may optionally influence the available choices in the eventgoer activity selector 862, or may optionally automatically influence or select the eventgoer activity selection 605 (e.g., if a crowd of eventgoers spontaneously begins an identified eventgoer activity, it may be identified within the eventgoer activity audiovisual output 706 using computer vision techniques or audio recognition techniques and self-identify in the eventgoer activity selector 862). If the eventgoer activity audiovisual output is to be sent to the transmitter, it is sent as a eventgoer activity audiovisual output (“F out”) 866 and may pass through the “conversion to transmitter” operations 355 to convert from a camera data format 870 to a transmitter type format before being sent to transmitter hardware controller 360.

In some cases, hardware or software switches may be also incorporated, such as switch 818 allowing the user to switch between audio-only or audiovisual data from a beacon, or a switch 838 allowing the user to switch from running beacon data format conversion operations 870 (converting beacon data format to transmitter data format) to running camera data format conversion operations 872 (converting camera data format to transmitter data format).

The output of the transmitter selector 860 may also be sent to the “conversion to transmitter” operations 355 as a list of transmitter identifiers 874, which may inform the beacon data format conversion operations 870 and camera data format conversion operations 872, so that these operations convert data into the correct format for each transmitter identified. The set of selected transmitters may include different types of transmitters that accept different formats of data, which may require different conversion operations.

The beacon data format conversion operations 870 (converting beacon data format to transmitter data format) and the running camera data format conversion operations 872 (converting camera data format to transmitter data format) both include the abilities to start sending converted data to a transmitter, to check the transmitter identifier data 874, to read the data that the transmitter is outputting, and to stop transmission of converted data.

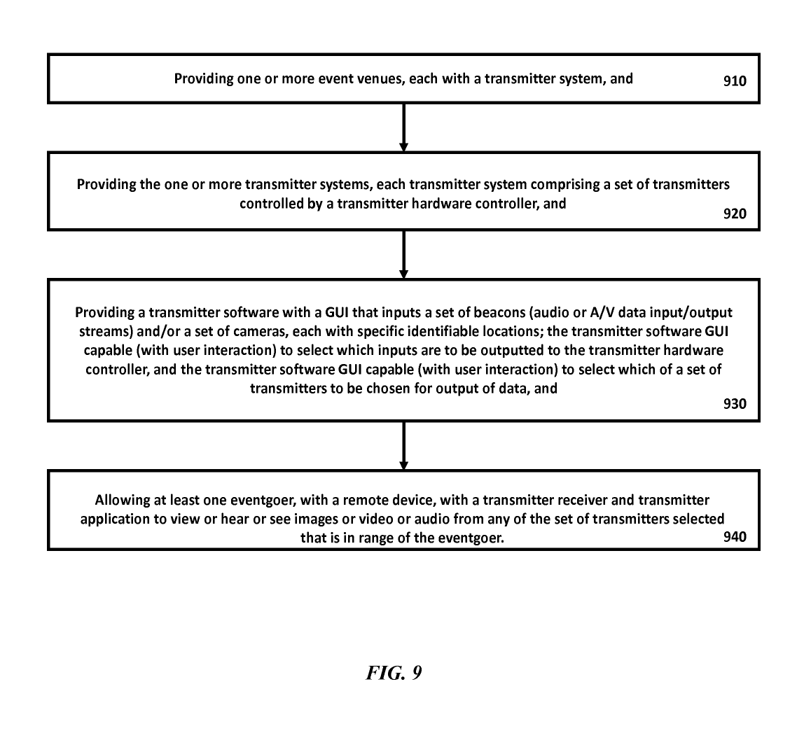

FIG. 9 illustrates an exemplary overall method of the present invention as described herein.

At step 910, the overall method includes providing one or more event venues 160, each with a transmitter system 205.

At step 920, the overall method includes providing the one or more transmitter systems 205, each transmitter system comprising a set of transmitters 210 controlled by a transmitter hardware controller 360.

At step 930, the overall method includes providing a transmitter software 380 with a GUI 350 that inputs a set of beacons 310 (audio or A/V data input/output streams) and/or a set of cameras 320, each with specific identifiable locations; the transmitter software GUI 350 capable (with user interaction) to select which inputs are to be outputted to the transmitter hardware controller 360, and the transmitter software GUI 350 capable (with user interaction) to select which of a set of transmitters 210 to be chosen for output of data.

At step 940, the overall method includes allowing at least one eventgoer 240, with a remote device 220, with a transmitter receiver 225 and transmitter application 230, to view or hear or see images or video or audio from any of the set of transmitters 210 selected that is in range of the eventgoer 240.

FIG. 10 illustrates an exemplary computing system 1000 that may be used to implement an embodiment of the present invention. The computing system 1000 of FIG. 10 includes one or more processors 1010 and memory 1010. Main memory 1010 stores, in part, instructions and data for execution by processor 1010. Main memory 1010 can store the executable code when in operation. The system 1000 of FIG. 10 further includes a mass storage device 1030, portable storage medium drive(s) 1040, output devices 1050, user input devices 1060, a graphics display 1070, and peripheral devices 1080.

The components shown in FIG. 10 are depicted as being connected via a single bus 1090. However, the components may be connected through one or more data transport means. For example, processor unit 1010 and main memory 1010 may be connected via a local microprocessor bus, and the mass storage device 1030, peripheral device(s) 1080, portable storage device 1040, and display system 1070 may be connected via one or more input/output (I/O) buses.

Mass storage device 1030, which may be implemented with a magnetic disk drive or an optical disk drive, is a non-volatile storage device for storing data and instructions for use by processor unit 1010. Mass storage device 1030 can store the system software for implementing embodiments of the present invention for purposes of loading that software into main memory 1010.

Portable storage device 1040 operates in conjunction with a portable non-volatile storage medium, such as a floppy disk, compact disk or Digital video disc, to input and output data and code to and from the computer system 1000 of FIG. 10. The system software for implementing embodiments of the present invention may be stored on such a portable medium and input to the computer system 1000 via the portable storage device 1040.

Input devices 1060 provide a portion of a user interface. Input devices 1060 may include an alpha-numeric keypad, such as a keyboard, for inputting alpha-numeric and other information, or a pointing device, such as a mouse, a trackball, stylus, or cursor direction keys. Additionally, the system 1000 as shown in FIG. 10 includes output devices 1050. Examples of suitable output devices include speakers, printers, network interfaces, and monitors.

Display system 1070 may include a liquid crystal display (LCD), a plasma display, an organic light-emitting diode (OLED) display, an electronic ink display, or another suitable display device. Display system 1070 receives textual and graphical information, and processes the information for output to the display device. The display system 1070 may include touchscreen input capabilities, such as capacitive touch detection.

Peripherals 1080 may include any type of computer support device to add additional functionality to the computer system. For example, peripheral device(s) 1080 may include a modem or a router.

The components contained in the computer system 1000 of FIG. 10 are those typically found in computer systems that may be suitable for use with embodiments of the present invention and are intended to represent a broad category of such computer components that are well known in the art. Thus, the computer system 1000 of FIG. 10 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, Android, iOS, and other suitable operating systems.

While various flow diagrams provided and described above may show a particular order of operations performed by certain embodiments of the invention, it should be understood that such order is exemplary (e.g., alternative embodiments can perform the operations in a different order, combine certain operations, overlap certain operations, etc.).

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A method for event venue communication, the method comprising:
receiving a first plurality of recorded datasets from a plurality of recording devices located at a plurality of locations within a performance area of an event venue;
combining the first plurality of recorded datasets into a first venue dataset;
receiving one or more secondary venue datasets;
receiving a selection input identifying a venue associated with a selected venue dataset, wherein the selected venue dataset is one of the first venue dataset or one of the one or more secondary venue datasets;
transmitting at least a subset of the selected venue dataset wirelessly to one or more receiver devices using one or more local wireless transmitters, where each local wireless transmitter of the one or more local wireless transmitters transmits data within a wireless transmission zone near the local wireless transmitter, wherein each wireless transmission zone includes at least a portion of an eventgoer area of an event venue.

2. The method of claim 1, further comprising converting the subset of the selected venue dataset from a first format associated with the recording device to a second format associated with at least a subset of the one or more local wireless transmitters.

3. The method of claim 1, wherein the subset of the selected venue dataset includes audio data.

4. The method of claim 1, wherein the subset of the selected venue dataset includes at least one of image data or video data.

5. The method of claim 1, further comprising splitting the selected venue dataset into a second plurality of recorded datasets using a demultiplexer.

6. The method of claim 5, wherein the selected venue dataset is the first venue dataset, and wherein the second plurality of recorded datasets is the first plurality of recorded datasets.

7. The method of claim 5, wherein the selected venue dataset is one of the one or more secondary venue datasets, and wherein the second plurality of recorded datasets is distinct from the first plurality of recorded datasets.

8. The method of claim 1, further comprising receiving a transmitter selection input identifying the one or more local wireless transmitters from a plurality of local wireless transmitters, the one or more local wireless transmitters being at least a subset of the plurality of local wireless transmitters.

9. The method of claim 8, wherein at least one of the dataset selection input or the transmitter selection input is an input into a user interface.

10. The method of claim 8, wherein at least one of the dataset selection input or the transmitter selection input is an automatic computer-generated input.

11. The method of claim 8, wherein the one or more local wireless transmitters are close to a particular event occurrence within the performance area of the event venue relative to the remainder of the plurality of local wireless transmitters.

12. The method of claim 8, wherein the one or more local wireless transmitters are far away from a particular event occurrence within the performance area of the event venue relative to the remainder of the plurality of local wireless transmitters.

13. The method of claim 1, wherein combining the first plurality of recorded datasets into a first venue dataset is performed using a multiplexer.

14. A system for event venue communication, the system comprising:
a plurality of recording devices located at a plurality of locations within a performance area of an event venue;
one or more local wireless transmitters, where each local wireless transmitter of the one or more local wireless transmitters transmits data within a wireless transmission zone near the local wireless transmitter, wherein each wireless transmission zone includes at least a portion of an eventgoer area of an event venue; and
a transmission controller device, wherein execution of instructions stored in a memory of the transmission controller device by a processor of the transmission controller device:
receives a plurality of recorded datasets from the plurality of recording devices,
combines the first plurality of recorded datasets into a first venue dataset,
receives one or more secondary venue datasets,
receives a selection input identifying a venue associated with a selected venue dataset, wherein the selected venue dataset is one of the first venue dataset or one of the one or more secondary venue datasets, and
transmits at least a subset of the selected venue dataset wirelessly to one or more receiver devices using the one or more local wireless transmitters.

15. The system of claim 14, further comprising at least one of a multiplexer or a demultiplexer.

16. The system of claim 14, wherein execution of the instructions by the processor of the transmission controller device further converts the subset of the selected venue dataset from a first format associated with the recording device to a second format associated with at least a subset of the one or more local wireless transmitters.

17. The system of claim 14, wherein the subset of the selected venue dataset includes at least one of audio data, image data, or video data.

18. The system of claim 17, wherein the subset of the selected venue dataset includes data associated with an eventgoer activity that is identified as at one of a cheers, a chant, a song, a dance, a motion, or some combination thereof.

19. The system of claim 14, further comprising a second plurality of recording devices associated with a second venue dataset of the one or more secondary venue datasets.

20. A non-transitory computer-readable storage medium, having embodied thereon a program executable by a processor to perform a method for event venue communication, the method comprising:
receiving a first plurality of recorded datasets from a plurality of recording devices located at a plurality of locations within a performance area of an event venue;
combining the first plurality of recorded datasets into a first venue dataset;
receiving one or more secondary venue datasets;
receiving a selection input identifying a venue associated with a selected venue dataset, wherein the selected venue dataset is one of the first venue dataset or one of the one or more secondary venue datasets;
transmitting at least a subset of the selected venue dataset wirelessly to one or more receiver devices using one or more local wireless transmitters, where each local wireless transmitter of the one or more local wireless transmitters transmits data within a wireless transmission zone near the local wireless transmitter, wherein each wireless transmission zone includes at least a portion of an eventgoer area of an event venue.
